(19) United States
(12) Patent Application Publication
(10) Pub. No.: US 2015/0045156 A1
(43) Pub. Date: Feb. 12, 2015

(54) Animal Attractant/Repellent Delivery Device, and System and Method for Delivery Thereof

(71) Applicant: Tim LAMMONDS, Winchester, VA (US)

(72) Inventor: Tim LAMMONDS, Winchester, VA (US)

(21) Appl. No.: 14/451,536

(22) Filed: Aug. 5, 2014

Related U.S. Application Data
(60) Provisional application No. 61/862,653, filed on Aug. 6, 2013.

(51) Int. Cl. A01M 31/00; F42B 6/00

(52) U.S. Cl. CPC A01M 31/00; F42B 6/00
USPC 473/577

(57) ABSTRACT

Disclosed herein is a scent carrying projectile comprising a scented portion made of a scent-carrying substance and a unscented portion, adjacent to said scented portion, said unscented portion made of an unscented substance. The scent carrying projectile can include a front conically shaped portion, a middle cylindrically shaped portion, adjacent to the front conically shaped portion, and an end cylindrical portion, adjacent to the middle cylindrical portion, wherein said front and middle portions are made of a scent-carrying substance, and further wherein said end cylindrical portion is made of an unscented substance. Further disclosed herein is a collapsible scent distributing airgun, a method of manufacturing a scented projectile, and a method of operating an collapsible scent distributing airgun with a scented projectile.

### TECHNICAL FIELD

The embodiments described herein relate generally to hunting devices, and more specifically to an animal attractant/repellent device and method for delivery of the same.

### BACKGROUND

Hunting in the United States is an extremely popular activity, especially in certain areas of the country. Hunting is generally considered a recreational activity, as very few people need to rely on their hunting prowess for sustenance. Nonetheless, whether it is small or large game, wild fowl or fishing, many participants do consume their catch. Hunting related industries include not only the firearms and ammunition, but also clothing, footwear, protective gear, hunting stands, scents, and many others.

Hunting scents, which can be used as both lures, repellants, and masks, are a substantial part of the hunting industry. The use of scents as lures and repellents is extremely popular in the United States today, as well as in several other areas of the world, including, for example, Canada, Great Britain, Germany and other parts Europe, Asia, and Africa. It can be presumed that wherever game is hunted, the hunter seeks to increase the odds of collecting it by using lures, masks, and/or repellents. A lure, as its name implies, attempts to lure, or attract, an animal closer to a location where a hunter can be hiding, sometimes referred to as “blinds” or “traps.” The smell of a female animal in estrous, for example, can make male animals seek to find the “female,” causing the male to come closer to the area the hunter is lying in wait. Strictly speaking, a mask is a scent that tries to cover the smell of one animal or thing (humans, most likely) with the scent of something that can be an attractant, repellent, or something else.

FIG. 1 illustrates a known hunting environment 20 in which hunter 6 uses scent 14 on certain areas around hunting blind 2, and/or applies a scent/mask on hunter 6 to mask the presence of hunter 6. Deer 16 is seen approaching blind 2, oblivious of the presence of hunter 6, because the attractive scent or lure 14 is one such that deer 6 is very attracted to. Further, mask 15 has been applied to the feet and legs of hunter 6 such that when dispersing scent 14, the scent of hunter 6 did not get dispersed around blind 2, which means that deer 16 probably has no idea that hunter 6 is in the vicinity. Through use of scent 14 and/or mask 15, hunter 6 has gained a tactical advantage in pursuing, hunting and killing deer 16.

As discussed above, hunting lures are popular in the USA, as well as in many other countries. Hunting and outdoor recreation, comprised of two major categories, hunting and fishing, and wildlife watching, is a significant part of our nation's economy. According to one source (see, http://www.sbdcnet.org/small-business-research-reports/hunting-and-outdoor-recreation), in 2011, over 108 billion dollars was spent in the outdoor recreation activities mentioned above, and of that, about 38 billion dollars in direct expenditures for hunting. Over 13 million people participate in hunting activities. Using well known multiplier effects, the economic effect of hunting activities increases to over 86 billion dollars. Thus, hunting activities, and its related equipment, are considerable parts of the U.S. economy.

Typically, lures, repellents, and masks can and have been applied in all sorts of manner, from sprays and aerosols, to pure liquids in containers, to paint-ball type dispersants and deodorant-stick like means for applying the scents to trees, hunting blinds, and the hunters themselves. Because of the money spent by enthusiasts, it should not be surprising that many people have obtained patent protection for their devices. There are at least several categories of methods/products that have either been patented, or for which applications have been made. These include the scents or animals attractants; pellet types devices, similar to a paintball, in which liquid scent is somehow placed; slug-type projectiles, some of which can have liquid or another scent carrying mechanism inserted therein; and wax-matrix type products, wherein the scent is imbued within the wax. Further, there are several different categories of mechanisms that can be used to fling the scent to intended areas. These include: slingshots; bow-and-arrow type devices; and of course, pistols/rifles.

In regard to scents or animals attractants, there is U.S. Pat. No. 6,149,901, to Weiser, entitled “Animal Scent Enhancer,” issued Nov. 21, 2000, and is directed towards animal scent attractants. The animal scent attractant includes a composition of matter for amplifying and preserving animal scents. Fox urine, coyote urine, deer urine, elk urine, moose urine, bear urine, rabbit urine, fish oils, and sheep manure are examples of substances that can be used. According to one example of the animal attractant of Weiser, the composition of matter is a powder comprising calcium carbonate and animal scent wherein the animal scent is preferably selected from the group consisting of liquid and freeze dried animal urine. The calcium carbonate is present in the composition between about 80-99%, most preferably between 85-95%, and the animal scent is present in the composition between about 1-20%, most preferably between about 5-10%. A percentage of animal scent below 1% results in a composition having an undesirable scent potency and a percentage of animal scent above 20% results in clumping of the powder. U.S. Pat. No. 6,685,929, to Burgeson et al., entitled “Viscous Scent Lure for Hunting,” issued Feb. 3, 2004, and is directed towards a viscous, non-liquid, non-gel scent lure for hunting, and consists of animal urine and a thickening agent. The thickening agent may comprise about 1% to about 7% by weight. The resulting viscosity of the solution ranges from about 1500 to about 10,000 centipoise. The viscous lure uses a thickening agent (Dow Methocel 4000), in the amount of 0.28 g. to 2 g. which is dissolved in 1 oz. of animal urine (preferably female deer urine). This produces a solution containing 1% to 7% of thickening agent (1 g.=0.035 oz.). About 0.57 g of Dow Methocel 4000 is dissolved in 1 oz. of animal urine, and this allegedly produces a scent lure that is thick enough to sling to smooth surfaces and that does not readily wash away in the rain. Further still, the scent lure is thin enough that it evaporates well, penetrates wick material effectively, flows slowly out of a bottle, adheres well to surfaces, and can allegedly penetrate into tight crevices. U.S. Pat. No. 6,855,313, to Parrigan, entitled “Animal Attractant,” issued Feb. 15, 2005, and is directed towards an animal attractant that is made from human urine and animal urine. The attractant consists of a mixture of 14 to 15 parts male human urine, and 1 to 2 parts animal urine. The human urine is aged for two to three days, and the attractant is a deer attractant. The attractant is a mixture of 14 to 15 parts human urine and 1 to 2 part deer urine. The human urine could be male, female, or female-during-menstruation human urine. The deer urine can be doe urine, doe urine in estrous, or buck urine, both natural and synthetic. The 6,855,313 patent alleges that male human urine mixed with synthetic buck urine works best.

In the pellet-type category of devices, U.S. Pat. No. 5,303,496 to Kowalkowski, entitled “Scent Distributing Method for Hunters,” issued Apr. 19, 1994, and is directed towards a method for applying a scent to a hunting or other desired location without approaching the area or contaminating it with human scent. The desired scent is placed in a carrying projectile means such as a pellet for a projectile delivery means such as a carbon dioxide operated gun and fired from a distance to the desired location. The pellet can generally be made out of gelatin, and is designed to carry a liquid, which, upon impact, breaks, spreading the liquid carrying scent. U.S. Pat. No. 5,353,712 to Olson, entitled “Marking Pellet Fun and Rigid Fracturable Pellet Therefor,” issued Oct. 11, 1994, and is directed towards a target shooting capsule comprising a non-toxic, bio-degradable, injection molded shell of various shapes and forms having a dry wall thickness of from about 0.001 inches to about 0.1 inches, having a diameter from about 0.125 inches to about 1 inch, and containing a brightly colored water washable, non-toxic liquid dye fill material. U.S. Pat. No. 6,199,311 to Foster, entitled “Scent Pellet and Method,” issued on Mar. 13, 2011, and is directed towards a scent pellet that can be used by hunters to dispel a game scent into a desired area without leaving a human scent. The scent pellet has a pair of hemispherical body members that are coupled together. A game scent is introduced into the pellet through a capped opening located on one of the body members. The pellet can be propelled, by way of a compressed gas gun, a slingshot, or by throwing, into the desired area such that the pellet strikes a relatively hard object. Some of the game scent is released through the opening during pellet flight. The pellet is constructed of a material that will break the pellet up upon striking the object thereby releasing the game scent. The pellet can be constructed from a biodegradable material. U.S. Pat. No. 6,880,765 issued to Tuomikoski, entitled “Scent Lure Dispenser,” issued on Apr. 19, 2005, and is directed towards a reusable scent lure dispenser. One disclosed embodiment can be made of a variety of materials, large enough to throw, comprising two hemispherical body members, each having a planar flange extending along and attached to their outer periphery, a releasable means to couple the body members by their flanges, and a means along the flanges' outer peripheries to form an airtight seal against one another, one body member also having scent openings on its flange within the means to form an airtight seal, and can include a scent carrier disposed within the interior of one of the body members. The lure dispenser can be colored for various appropriate applications. Reflective material may be attached to the exposed surfaces of the hemispherical body members to allow easy retrieval at night. A tab with a mounting hole can allow easy hanging, such as in a tree. U.S. Published Patent Application No. 2012/0028742, filed by Van Der Linden, entitled “Scent Shooter,” published on Feb. 2, 2012, and is directed towards a scent shooter apparatus and scent filled pellet. The scent shooter can include a projectile launcher, and vessel can be coupled to the projectile launcher and configured to hold a pellet and release the pellet during operation of the apparatus. The apparatus can include a piercer mounted on the vessel, such that the piercer can be disposed to pierce the pellet during operation of the apparatus. The scent filled pellet can further include a hardened shell, and a control release agent may be disposed inside the pellet to control release of the scent.

In the slug/cartridge type category of devices, U.S. Pat. No. 3,528,662 to Merchant, et al., entitled “Material Dispensing Projectile,” issued on Sep. 15, 1970, and is directed towards a projectile for dispensing liquid or powder material on a target upon impact and including a frangible cartridge having a weakened portion adapted to form a dispensing opening upon rupture of the cartridge. U.S. Published Patent Application No. 2007/0181031, entitled “Frangible Slug,” filed by Romero, published on Aug. 9, 2007, and is directed towards methods and articles that can produce frangible slugs. A method of manufacturing a frangible slug includes heating substantially spherical metallic powdered particles, wherein substantially all of the powdered particles have diameters larger than 125 microns and smaller than 250 microns, to form heated powdered particles. The method includes heating a microcrystalline wax, to form a melted wax. The method also includes combining the heated powdered particles with the melted wax, to form a liquid mixture. The method further includes filling a payload cavity of a frangible slug container with the liquid mixture to form a liquid mixture payload. The frangible slug of Romero is typically used as a “door slug,” preferably by law enforcement individuals, to break down doors of alleged criminals, and the like. While Romero fails to discuss any aspect of hunting, and no mention of scenting, the frangible slug of Romero is significantly massive to be fired from a more-conventional type firearm, but operates in a completely different manner. The frangible slug of Romero is designed to literally disintegrate a very short time and distance after firing; its main use is to break door hardware apart, but then become very quickly inoperative, which it accomplishes by mixing melted wax with the metallic powdered particle so that it impact with a solid object causes it to fall quickly apart following firing. U.S. Published Patent Application No. 2012/0085259, entitled “Cartridge for Light-Weighted Projectile, filed by Cronemberger, published on Apr. 12, 2012, and is directed towards a cartridge for light weighted projectiles. The cartridge of Cronemberger can fire a light-weight projectile, producing a pressure curve of the propellant gases similar to the pressure curve generated by the shot of a heavy weighted lead-core projectile. The cartridge propels the light-weighted projectile together with a capsule, which contains an inert load of high density metal powder. The capsule is divided in multiple parts, which disassemble when it leaves the firearm muzzle, spreading the metal powder in the air. The metal powder increases the mass which is accelerated by the propellant gases, keeping the pressure curve high enough to cycle a self-loading firearm mechanism. The metal powder consists of very thin particles which spreads and decelerates rapidly in the air, causing a controllable level of danger to personnel.

In the wax-matrix type category of devices, there is U.S. Published Patent Application No. 2003/0071390, entitled “System and Method for Producing a Bait Station of Wax Matrix Material,” filed by Robinson, published on Apr. 17, 2003, and is directed towards a system and method of mass-producing a bait station of wax matrix material for pesticide or insecticide delivery. The apparatus and method includes a water-heated vat that supplies liquid wax matrix material to molds that may be of various forms in accordance with the desired bait station to be manufactured. A fluid pump pumps the wax matrix material from the vat through a tube into molding tubes. At a molding tube station, the molds are filled and then carried by a conveyer belt to a cooling tunnel. The wax-containing molds may be shaken by an in-line shaker in order to reduce air bubbles in the wax matrix. After the wax-containing molds are cooled by the cooling tunnel the conveyer carries them to a labeling station, after which the finished bait stations are removed from their molds and packaged. As further disclosed in the Robinson Application, the molds may be shaped to form bait stations that are thin strips of material that can be hung from or affixed to trees or other objects in the field. Alternatively, the molds may be in the shape that forms pellets that can be fired at objects such as trees in the field to form bat stations. At least one problem associated with such pellets, and strips, is that the scent that might be in the pellets could get on the fingers of the user when placing them in a pellet-expelling device. Further, such pellets may not have sufficient rigidity to be used in a gun-like device to be expelled a sufficient distance from the user of such devices. U.S. Pat. No. 6,632,786 to Wyatt, entitled “Attractant Scent and Solid Delivery Vehicle and Method Manufacture,” issued Oct. 14, 2003, is directed towards an attractant scent and solid delivery vehicle that allows the application of attractant scent or other types of scent using a solid delivery vehicle, from a convenient container similar to that used for underarm deodorant. The attractant scent is typically animal urine, but other attractant scents or other types of scents, could be substituted. Approximately 40 parts water, 30 parts urine or other attractant, and 30 parts propylene glycol are mixed in a double-jacketed container. Following heating and mixing, the cooling liquid can be poured into containers that include those used for underarm deodorant. In use, the attractant scent and solid delivery vehicle can be advanced from the container and a portion of the solid applied to form a thin coating on any desired surface, such as the bottom of a boot. U.S. Pat. No. 6,648,239 to Myny et al., entitled “Device for Dispensing Animal Scents,” issued on Nov. 18, 2003, and is directed towards a device for dispensing animal scents, for the attracting of animals such as deer. The device comprises a cylindrical outer housing, an inner assembly, slidably received within the housing and an absorbent wick disposed within the inner assembly for saturation with a liquid attractant such as deer urine. The inner assembly comprises a hollow cylinder with a wick disposed there through, and has a plurality of holes allowing the scent given off from the liquid attractant to diffuse into the air. The device can be selectively closed when so desired to prevent unnecessary dissipation of the attractant, and further prevent unnecessary evaporation.

In regard to devices that can propel, or expel pellets, slugs and/or cartridges, there is first a slingshot type device. U.S. Pat. No. 7,900,620 to Walters et al., entitled “Slingshot Construction,” issued on Mar. 8, 2011, and is directed towards a slingshot for delivering (firing) a fragile, easily breakable shelled pellet, such as a gelatin shelled game scent ball, to a target site in a woods, field, or the like, whereby the pellet breaks apart at impact at the target site and disperses the scent. The pellet carrying breech structure is affixed to the slingshot pouch or firing bands, and is provided with an axially oriented pellet receiving cavity partly defined by flexible fingers which can hold the pellet in place when cocking the slingshot but that easily releases the pellet on firing. Such pellets are very common nowadays, for example, for use in paint ball activities. These pellets suffer from known deficiencies such as their frangibility, which can cause them to break apart before their intended use. For example, hunters could break the pellet apart in their hands. Further, gelatin is notoriously hydrophilic, meaning the slightest bit of moisture causes the gelatin to start breaking down. The Walter's patent allegedly overcomes that particular deficit by internally coating the pellet with wax, and can also form the outer shell as wax itself. However, such wax pellets would suffer from at least being far too soft to be fired from anything other than a slingshot.

In further regard to propelling and expelling type devices, there are bow-and-arrow type devices. U.S. Pat. No. 5,033,446 to Bradt, entitled “Scent Projectile Missile and Launcher,” issued on Jul. 23, 1991, and is directed towards a device and method for better enabling outdoors-people to see more wild animals up more closely by helping to cover up or mask their human scent at a greater distance. The outdoorsman arrives at his or her desired location and then proceeds to launch scent missiles (loaded with desired scent) in different directions, using the launcher. Typically four such scent missiles will be launched in directions approximately ninety degrees from each other. This surrounds the outdoorsman with natural woodsy odors thereby covering up or masking his/her own human odors. In a second type of device, U.S. Published Patent Application No. 2010/0197430, entitled “Projectile Launched Media Reservoir,” filed by Martin, and published on Aug. 5, 2010, is directed towards a projectile having a launching assembly attached thereto for marking a remote location with a marking media. The marking media is preferably in the form of a paint ball or a scent ball. The launching assembly includes a media reservoir defining a cavity and a plurality of supports extending outward from the media reservoir along a longitudinal axis. The supports secure the marking media within the cavity in a press-fit connection. In one embodiment, a cap and a resilient nose cone are attached to the media reservoir, surrounding the marking media, to prevent damage to a target upon impacting the target. U.S. Published Patent Application No. 2012/0153036, entitled “Scent Dispersing Apparatus,” filed by Pierce et al., published on Jun. 21, 2012, and is directed towards a scent dispersing apparatus is discussed that includes an animal attractant, such as a liquid scent, that can be dispersed from a soft-shelled frangible capsule by positioning the capsule in an enclosure and then attaching the enclosure to an arrow. A plunger secured to the enclosure slidably moves inside the enclosure and causes rupture of the capsule upon impact of the plunger with a solid surface. The liquid animal attractant is dispersed through cutouts formed in the enclosure in a fan-like fashion.

In still further regard to propelling and expelling type devices, there are gun/rifle type devices. U.S. Pat. No. 5,456,036, to Butz, entitled “Animal Scent Dispensing Piston Assembly, issued on Oct. 10, 1995, and is directed towards an animal scent dispensing pistol assembly for dispensing scent for attracting animals. The dispensing pistol assembly comprises a pistol including a barrel having a sealed base end, an opened tip end, and a bored intermediate portion therebetween. The pistol further includes a handle extended from the barrel, a plunger slidably disposed within the barrel, and a spring mechanism disposed within the barrel and coupled to the pistol for urging the plunger towards the tip end of the barrel. Still further, the pistol includes a cocking mechanism coupled to the plunger and adapted to be actuated for urging the plunger towards the base end of the barrel to define a retracted orientation. A trigger mechanism is also included and coupled to the pistol. The trigger mechanism has a rest position for holding the plunger in the retracted orientation and a firing position actuatable for releasing the plunger from the retracted orientation. For use with the pistol there are a plurality of scent sticks each adapted for holding liquid scent, each scent stick further adapted to be inserted into the barrel of the pistol for subsequent ejection therefrom. PCT Published Applicant No. WO 2008/065218 discusses a method for controlling pests that includes shooing capsules that are filled with pesticides. Also, Spanish patent 9702573 discusses a conventional rife bullet, affixed to the front of which is a layer of wax that contains there within an insecticide. Of course, a rifle bullet that is fired from a rifle can be significantly more dangerous than any of the other forms or means for spreading lures/repellents/attractants that have been discussed thus far, or below. U.S. Published Patent Application No. 2008/0313947, entitled “Scent Distribution System, Method and Device,” filed by Fachner, published on Dec. 25, 2008, and is directed towards a scent distribution system, method, and device for distributing lure. The scent distribution system includes a gun that has a barrel portion, having a chamber disposed therein, and a handle portion, coupled to the barrel portion and extending substantially orthogonal therefrom. A first projectile is provided that includes a luring scent configured to lure prey, and which can be disposed within the chamber of the barrel portion. The handle portion comprises a storage compartment disposed within the handle portion. There is a second scented projectile, disposed in the storage compartment. The storage compartment is air-tight. The first projectile comprises an absorbent portion including a fluid scent disposed therein. The first projectile includes a flexible portion disposed at a back-end of the projectile and configured to provide air-flow resistance when disposed within the chamber, thereby permitting the projectile to be launched by an imbalance in air pressure. U.S. Published Patent Application No. 2009/0255434, entitled Method and System for Controlling Small Wild Animals and Rodents,” filed by Pawloski, published on Oct. 15, 2009, and is directed towards a control system that is in the form of a portable kit that includes a launching device, a plurality of thermoplastic hollow projectiles, a supply of a natural animal control agent for loading into the projectiles, and a means for transferring and storing the control agent. The method of use of the control system involves filling the projectiles with the control agent and then sealing the projectiles prior to loading the projectiles into the launching device. The launching device is then aimed at an area that is being controlled by the animal and then the projectiles are discharged from the gun so as to disperse the control agent about the area being controlled. The control agent causes a biological reaction in the animals and rodents when they detect the scent of the control agent. The biological reaction causes a fear and intimidation response in the brain of the animals and rodents, such that they will voluntarily and permanently vacate the nest out of fear for its life and of its young. The control agent is a urine, marking gland oil or a combination of oil and urine, from a known predator of the animal or rodent. Further in this category, there is U.S. Pat. No. 8,118,017 to Lammonds, entitled “Scent Distribution Airgun,” issued on Feb. 21, 2012, and is directed towards a collapsible scent distributing airgun (“airgun”) that can include a body and a gas cartridge, which may be carried by the body and contain a pressurized gas. The airgun can also have a pressure regulator valve, which can be carried by the body and communicated with the gas cartridge. In addition, the airgun can also have a barrel that can be pivotally carried by the body and movable between collapsed and extended positions. The barrel in the extended position can have an end communicated with the pressure regulator valve to receive the pressurized gas, and further wherein the barrel in the collapsed position, can have the end adapted to receive a projectile configured to emit a scent. The airgun can further include a trigger that can be pivotally carried by the body and coupled to the pressure regulator valve to selectively direct the pressurized gas into the barrel for launching the projectile.

An additional apparatus is known to those of skill in the art. These include wax bullets that are made up entirely of soft wax, and inserted into conventional firing cartridges that can be used for practice and training exercises. See, e.g., http://en.wikipedia.org/wiki/Wax_bullet; http://www.waxbullet.com/; http://www.cowboyfastdraw.com/secureshop/index.php?dispatch=categories.view&category_id=167; and http://www.easyloaderexpress.com/. Typically, such wax bullets are low velocity devices, but high velocity bullets can also be fashioned. However, none of the examples thus cited of wax bullets envisions anything other than relatively soft wax that can be re-used, but in addition require the use of cartridges to be fired from a gun.

Thus, it is clear to those of skill in the art that there are certain problems with existing technologies for dispersing scents when hunting. Accordingly, it would be desirable to provide methods, modes and systems for an animal attractant/repellent delivery apparatus.

### SUMMARY

An object of the embodiments is to substantially solve at least the problems and/or disadvantages discussed above, and to provide at least one or more of the advantages described below.

It is therefore a general aspect of the embodiments to provide a scent carrying projectile and apparatus for delivering such scented projectile, such as a compressed gas scented projectile delivery device that will obviate or minimize problems of the type previously described. According to a first aspect of the embodiments, a scent carrying projectile is provided, comprising a scented portion made of a scent-carrying substance, and a unscented portion, adjacent to said scented portion, said unscented portion made of an unscented substance. Still further according to the first aspect, said scent-carrying substance and said unscented substance are made of said same substance, and wherein said scent-carrying substance includes a scent and said unscented substance does not include said scent. According to the first aspect, said substance comprises a substance that is melted and then cooled and solidified, such that a first hardness in a pre-melted state is less than a second hardness in a post-melted state.

Still further according to the first aspect, said scented portion and said un-scented portion are covered with a thin, unscented membrane, and wherein said membrane is made of at least one of paper, tissue, foil, and plastic, and wherein said projectile is substantially cylindrically shaped.

According to the first aspect, said scented portion comprises a conically shaped scented front portion, and a cylindrically shaped scented rear portion, and wherein said unscented portion comprises a cylindrically shaped unscented front portion adjacent said cylindrically shaped scented rear portion of said cylindrically shaped scented portion, and a cylindrically shaped unscented rear portion.

According to the first aspect, said scent includes urine selected from the group of male deer, female deer, female deer in estrous, male bear, female bear, female bear in estrous, male fox, female fox, female fox in estrous, male coyote, female coyote, and female coyote in estrous.

According to a second aspect of the embodiment, a scent carrying projectile is provided comprising a front conically shaped portion, a middle cylindrically shaped portion, adjacent to the front conically shaped portion, and an end cylindrical portion, adjacent to the middle cylindrical portion, wherein said front and middle portions are made of a scent-carrying substance, and further wherein said end cylindrical portion is made of an unscented substance.

According to the second aspect, said scent-carrying substance and said unscented substance are made of said same substance, and wherein said scent-carrying substance includes a scent and said unscented substance does not include said scent, and further wherein said same substance comprises a substance that is melted and then cooled and solidified, such that a first hardness in a pre-melted state is less than a second hardness in a post-melted state.

Still further according to the second aspect, said projectile is covered with a thin, unscented membrane, and said middle cylindrically shaped portion includes a cavity filled with scent-carrying gel. According to the second aspect, said projectile is covered with a thin, unscented membrane, and said middle cylindrically shaped portion includes a cavity filled with scent-carrying liquid.

According to the second aspect, said projectile is covered with a thin, unscented membrane, and wherein said membrane is made of at least one of paper, tissue, foil, and plastic. Still further according to the second aspect, said scent includes urine selected from the group of male deer, female deer, female deer in estrous, male bear, female bear, female bear in estrous, male fox, female fox, female fox in estrous, male coyote, female coyote, and female coyote in estrous.

According to a third aspect of the embodiment, a scent carrying projectile is provided comprising a cylindrically shaped scented portion made of a scent-carrying substance, and a thin unscented membrane covering substantially all of said cylindrically shaped scented portion.

According to the third aspect, said projectile further comprises a cavity in said projectile filled with scent-carrying gel. According to the third aspect, said projectile further comprises a cavity in said projectile filled with scent-carrying liquid. Still further according to the third aspect, said cylindrically shaped portion comprises a tapered shaped portion, configured to be a front end of said projectile, and a rear end of said projectile, wherein said rear end of said projectile is cylindrically shaped. Still further according to the third aspect, said tapered shaped portion is shaped substantially similar to one of a conical shape, a parabolic shape, a pyramid shape, and a spherical shape, and wherein said substance comprises a substance that is melted and then cooled and solidified, such that a first hardness in a pre-melted state is less than a second hardness in a post-melted state.

According to the third aspect, said projectile is covered with a thin, unscented membrane, and further wherein said membrane is made of at least one of paper, tissue, foil, and plastic.

According to the third aspect, said scent includes urine selected from the group of male deer, female deer, female deer in estrous, male bear, female bear, female bear in estrous, male fox, female fox, female fox in estrous, male coyote, female coyote, and female coyote in estrous.

According to a fourth aspect of the embodiments, a collapsible scent distributing airgun is provided comprising a body, a source of pressurized gas, a pressurized gas release mechanism configured to selectively release said pressurized gas, and a barrel configured to accept a projectile for firing by said selectively released pressurized gas, and a rotatable barrel holder assembly that includes a first detent mechanism configured to interface with a second detent mechanism located on said body, and wherein said first and second detent mechanisms are configured to temporarily lock said barrel into a firing position on said body.

According to the fourth aspect said airgun further comprises a pressure regulator valve carried by the body and configured to regulate flow of said pressurized gas from said source of pressurized gas, and a trigger pivotally carried by the body and coupled to said pressure regulator valve and configured to selectively direct said pressurized gas into said barrel by interfacing with said pressure regulator valve in said firing mode of operation, and wherein said rotatable barrel holder assembly is configured to rotatably mount said barrel to the body such that said barrel can be temporarily fixedly locked into a firing position.

According to the fourth aspect, said barrel includes an upper end and a lower end, wherein said upper end is configured to accept said projectile for firing, and said lower end is configured to expel said projectile when fired, and said rotatable barrel holder assembly further comprises a holder mating fixture, mechanically and in a gas-exchanging manner coupled to said body such that said pressurized gas can pass through said holder mating fixture, and wherein said holder mating fixture is configured to removably fixedly interconnect with said rotatable barrel holder assembly in a rotating manner.

Still further according to the fourth aspect said holder mating fixture is further configured to temporarily lock said rotatable barrel holder assembly in said firing position, and said holding mating fixture further includes a gas delivery channel to delivery said pressurized gas to said barrel, and further wherein said rotatable barrel assembly includes a rotatable barrel holder that includes a gas discharge channel aligned with said gas delivery channel when said rotatable barrel assembly is not in a firing position, such that when pressurized gas is discharged when said rotatable barrel assembly is not in the firing position, said pressurized gas is discharged through said gas delivery channel and then through said gas discharge channel into the atmosphere.

According to the fourth aspect, said first detent device is a detent receptacle, and said second detent device is a detent protrusion. According to the fourth aspect, said second detent device is a detent receptacle, and said first detent device is a detent protrusion.

According to the fourth aspect, said rotatable barrel assembly is further configured to discharge said pressurized gas into the atmosphere when said rotatable barrel assembly is not in the firing position, and further wherein, said rotatable barrel assembly is further configured to discharge said pressurized gas into the atmosphere but not through said barrel.

According to the fourth aspect, said source of pressurized gas comprises a gas cartridge carried by said body and containing said source of pressurized gas, and said source of pressurized gas comprises an external cartridge of pressurized gas not carried by said body, and pneumatically connected to said pressurized gas release mechanism of said airgun.

According to a fifth aspect of the embodiments, a method of manufacturing a scented projectile is provided, comprising melting a first portion of a projectile substance, adding a scent to the melted first portion of projectile substance, pouring said scented melted first portion of projectile substance into one or more projectile molds such that each of the one or more molds is partially filled, cooling said molds partially filled with scented melted projectile substance, melting a second portion of a projectile substance, pouring said melted second portion of projectile substance into each of the one or more projectile molds such that each of the one or more molds is substantially completely filled to form one or more scented projectiles, cooling said substantially filled one or more projectile molds, and extracting said cooled one or more scented projectiles.

According to a sixth aspect of the embodiment, a method of operating an airgun with a scented projectile is provided, comprising inserting into said airgun a scented projectile composed of a first portion that contains scented projectile substance and a second portion that is an unscented projectile substance, and wherein said projectile substance was melted to form said first and second portions, trigging a release mechanism that releases a pressurized gas to expel said scented projectile from said airgun, and aerating a location where said scented projectile lands with said scent of said scented projectile.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified, and wherein:

FIG. 1 illustrates a typical hunting environment in which hunter uses scent on certain areas around hunting blind, and/or applies a scent/mask on hunter to mask the presence of hunter;

FIGS. 2A-E illustrate perspective views of a cylindrically shaped scented projectile that can be used to attract animals and repel animals according to an embodiment, and FIGS. 2F-J illustrate perspective views of a non-cylindrically shaped scented projectile according to an embodiment;

FIG. 3 illustrates a method flowchart for the manufacture of scented projectiles according to an embodiment;

FIG. 4 illustrates an apparatus that can be used to manufacture scented projectiles according to an embodiment;

FIG. 5 is a perspective view of one embodiment of a collapsible scent distributing airgun, showing the airgun having a barrel moved to an extended position according to an embodiment;

FIG. 6 is an exploded view of the airgun of FIG. 5;

FIG. 7 is a side view of the airgun of FIG. 5, showing the barrel moved to a collapsed position to permit a projectile to be loaded into the barrel;

FIG. 8 is a top view of the barrel of FIG. 5;

FIG. 9 is a side view of the barrel of FIG. 5;

FIG. 10 is an end view of the barrel of FIG. 5;

FIG. 11 is a perspective view of a rotatable barrel assembly according to a further embodiment;

FIG. 12 is a side view of the rotatable barrel assembly of FIG. 11;

FIG. 13 is a side view of the rotatable barrel assembly of FIG. 11 in an accidental gas discharge mode according to an embodiment;

FIG. 14 is a side view of the rotatable barrel assembly of FIG. 11 in a normal gas and scented projectile discharge mode;

FIG. 15 illustrates a detent protrusion that is part of the rotatable barrel holder and a detent receptacle that is part of holder mating fixture according to an embodiment; and

FIG. 16 illustrates a marine use of the scented projectile shown in FIGS. 2A-J, and a modified airgun as shown in FIG. 5 according to an embodiment.

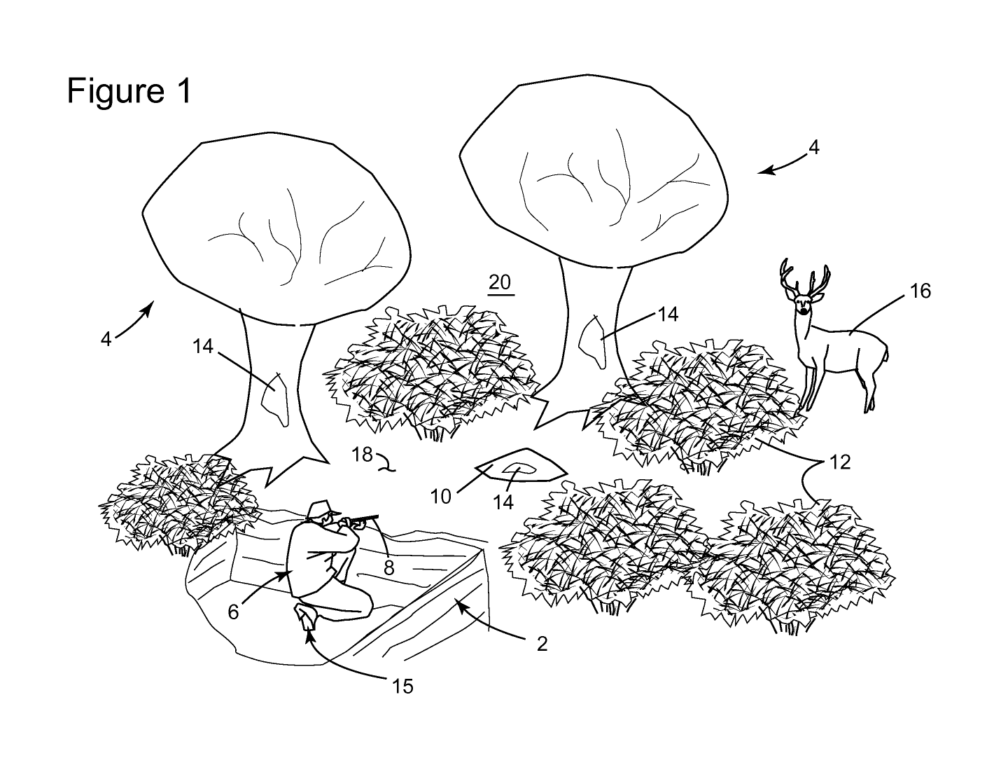

### DETAILED DESCRIPTION

The embodiments are described more fully hereinafter with reference to the accompanying drawings, in which embodiments of the novel concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the novel concept to those skilled in the art. The scope of the embodiments is therefore defined by the appended claims. The following embodiments are discussed, for simplicity, with regard to the terminology and structure of hunting lures, and more specifically to an animal attractant/repellent apparatus and method for delivery of the same. However, the embodiments to be discussed next are not limited to these types of apparatus, but may be applied to other attractant/repellant apparatus that are affected by the same or substantially same prior art problems.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

Scented Projectiles

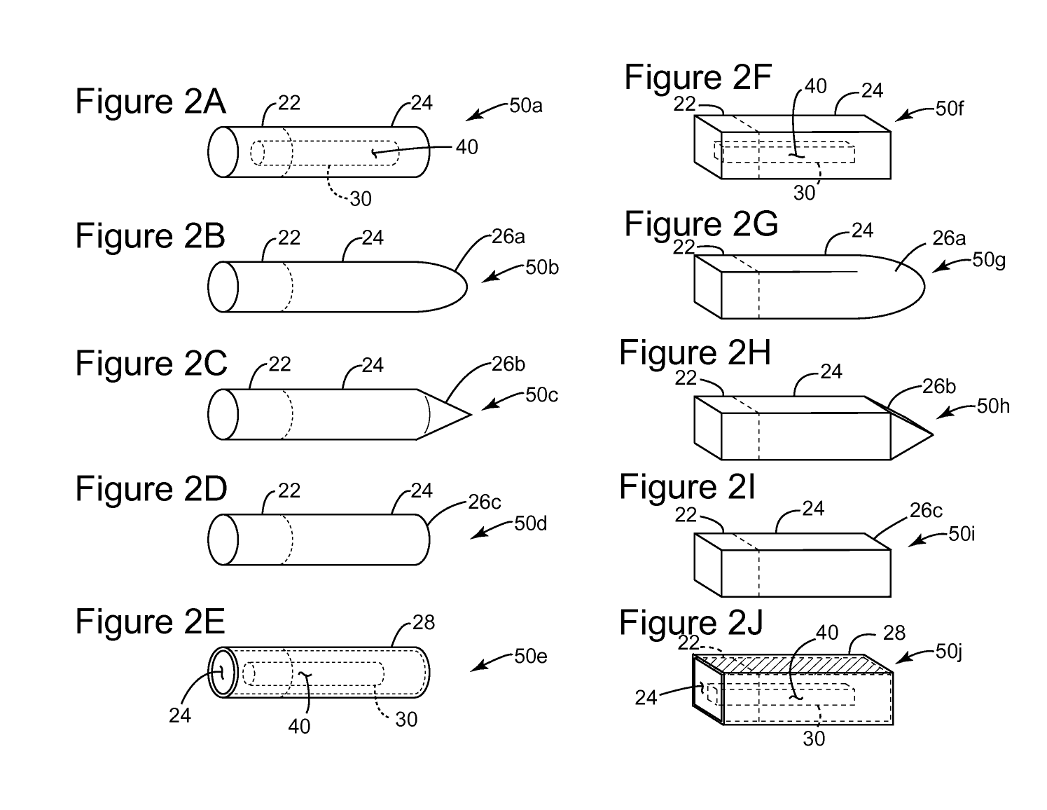

FIGS. 2A-J illustrate perspective views of scented projectiles 50a-j that can be used to attract animals and repel animals according to an embodiment. As discussed above, the use of scents to attract and repel animals is fairly prevalent in the hunting industry. There are many reasons why scents work to attract and repel animals, and perhaps dozens, if not hundreds, of different scents that can be used. Most often, the scents are based on urine, which can contain different chemicals that can create the scent that is either attractive or repellent for some reason to the animal in question.

For example, during mating season, female deers, or does, go into estrus and start producing specific hormones that cause the urine of the doe to emit specific odors or scents that are noticeable to male deers, causing them to pursue the does for mating. Of course, it does not need to be mating season for the male deer, or buck, to be attracted to the odor of estrus. This allows the scent to be used throughout the year, consistent with hunting regulations, i.e., hunting “seasons.”

Thus, and using the example of deer hunting, though one of skill in the art can appreciate that scents and lures apply to many different animals, hunter 6, when hunting, would like to use scents/lures 14 that attract bucks to the location of their hunting location, or hunting blind (blind) 2, to make it easier to hunt their targeted animal. As done in the past, using typical conventional devices, hunter 6 would have to traipse out to the neighboring trees and rocks, dousing them with spray from a spray bottle, or rubbing a deodorant-stick type material, or something similar. In the process, hunter 6 is very effectively spreading his or her own scent in the same area. Of course, some deer can be used to the smell of humans, but some are not, and many other types of animals that are generally situated far from habited places are definitely not used to the smell of humans. This, then, would cause the animals to be repelled from the area, or at best be confused about some area; in either case, hunter 6 has wasted time, money and a hunting opportunity because the targeted animal, in this example a deer, just will not come close enough to blind 2 for hunter 6 to take an effective and safe shot at the target. This is especially true when hunter 6 is using, for example, a bow and arrow.

Nonetheless, hunter 6 can alleviate such problems, to a certain extent, through the use of sprays, wipes, and the like, that can be applied to the boots, pants, and other exterior garments hunter 6 might be wearing before application of scent/lure 14 to the neighboring area. But, as one might well imagine, a urine based scent/lure 14 smells like urine, which can be odoriferous. So, hunter 6 now smells like urine. This is okay as long as hunter 6 is hunting, but probably not so much for returning to their homestead. Further, such smells might be difficult to eliminate even with repeated washings.

Hunter 6 then might be tempted to use other conventional type scent dispersing systems, such as was discussed in the Background section of this document. However, those all typically suffer from one or more of several different issues. If they are frangible, and contain liquid, they are subject to breakage at the wrong time (i.e., when being held by hunter 6), or not breaking when they are supposed to (i.e., landing in soft grass that fails to cause them to disperse their liquid scent). Slingshots are more difficult to aim than guns, and round pellets are not as likely to fly straight to their intended target (hence the development of the rifled bullet over the musket ball).

As further discussed above, there are many prior art conventional systems that all suffer from one or more deficiencies. Scented projectile 50, however, can be used with projectile delivery device (airgun) 100 (discussed in greater detail below) to effectively, and efficiently deliver attractants, repellent and masking scents 14 to and around blind 2 with little or no danger of getting scent 14 on the body of hunter 6, or requiring hunter 6 traipse all around blind 6, causing human scent to be dispersed, and/or the application of some masking scent to the body of the hunter.

Scented projectile 50 can be used in several different configurations. FIG. 2A illustrates a first example of scented projectile 50a. Scented projectile 50a is comprised of front portion 24 and end portion 22. Both front portion 24 and end portion 22 can be made of the same substance, processed projectile substance 34, which is comprised of raw projectile substance 32 that is then processed to form processed projectile substance 34. In its raw, unprocessed state, raw projectile substance 34 is less hard and a more malleable substance than its processed state. During processing (discussed in greater detail below), raw projectile substance 32 can have scent 14 added to it, as well as dyes or colors, to form processed projectile substance 34, which is substantially harder than raw projectile substance 32. Processed projectile substance 34 can therefore be used effectively in airgun 100, whereas raw projectile substance 32 could not be used as effectively in airgun 100.

As mentioned above, scent 14 and color or dyes 38 can be added to raw projectile substance 32 during processing to form scented projectile 50. Colors or dyes 38 can be used to identify the intended use of scented projectile 50 (i.e., green for deer, red for bear, and so on), and can also further distinguish between front portion 24 and rear portion 22. For example, rear portion 22 could always be white to alert hunter 6 which end is which through such visual means. As mentioned above, one recurring issue with prior art systems is that there is always the possibility of spillage, or breakage, of the liquid scent. According to an embodiment, using a visual identification, such as coloring the rear (unscented) portion differently from the front (scented) portion will aid hunters 6 in keeping scent 14 off their fingers. Another means according to another embodiment is to use some other visual identifier, such as marking of some type, or to imprint a label “UNSCENTED” on the unscented portion. According to a further embodiment, the scented portion can be the rear portion 22 and the unscented portion can be front portion 24.

According to an embodiment, scented projectile 50 will disperse scent 14 from scented processed projectile substance because the oils that make up scent 14, and have been mixed with processed projectile substance 34, contain the scent molecules that are released, albeit slowly, from processed projectile substance 34 into the air. Although the process is slow, it is effective because animals tend to have a large amount of olfactory receptors, typically several times as many as humans. For example, a deer has about 297 million olfactory receptors, and a human about 5 million. A bloodhound has about 220 million olfactory receptors. A silvertip grizzly bear has a sense of smell that is about seven times better than the bloodhound. According to some sources, the grizzly therefore has a sense of smell about a million times better than that of a human, with about a billion olfactory receptors (see, http://bearinfo.blogspot.com/2007/08/grizzlies-are-sniffing-champs-of-wild.html). Using a solid to contain the scent molecules assists hunter 6 in achieving their objective, which is to attract, via smell, a desired animal, because of the substantially great amount of time the scent molecules will be released into the local atmosphere as compared to a more volatile liquid. Comparatively speaking, liquid scents, such as those used in prior art convention scent dispersing systems will release a larger quantity of scent molecules much more rapidly, but this will generally be less effective as the effect lasts for a shorter period of time. If there are no animals in the area to smell scent 14, and if it disperses rather quickly, then it has been all for nought. In contrast, in accordance with embodiment, releasing smaller amounts of scent 14, which is still effective, over longer periods of time, will increase the possible number of animals that can smell scent 14 and be attracted to the area near blind 2.

Thus, hunter 6 can disperse one or more scented projectiles 50 around the area of blind 2, and each will release scent 14 over a prolonged period of time, increasing the odds of hunter 6 successfully hunting the targeted animal.

Returning attention again to FIG. 2A, scented projectile 50a can optionally according to a further embodiment further comprise reservoir 30 that can be filled with liquid or gelatinized scent 40. Reservoir 30 can be filled with liquid/gelatinized scent 40 during the manufacturing process. In use, scented projectile 50a with reservoir 30 can be fired from airgun 100 and upon impact with, for example, tree 4 or rock 10, can burst open, providing an immediate and significant release of scent molecules that will quickly disperse into the air in the area of blind 2 to attempt to rapidly attract the desired game for hunting. Then, as time proceeds, and the scent molecules from liquid/gelatinized scent 40 are disperses, the scent molecules from processed projectile substance 34, which are slowly being released from processed projectile substance 34 upon the initial firing of scented projectile 50, will be dispersed into the same air around blind 2, thus providing sustained coverage of scent 14.

According to an embodiment, scented projectile 50 is between about 0.25 to about 0.5 inches in diameter, and according to a further embodiment, is about 0.375 inches in diameter. According to an embodiment, scented projectile 50 is between about 1 to about 2 inches in length, and according to a further embodiment, is about 1.5 inches in length. According to still a further embodiment, scented projectile can be between about 2 to 5 times larger in both diameter and length for a marine use according to an embodiment. According to a further embodiment, and as can be appreciated by those of skill in the art, such dimensions are for illustrative purposes only, and are not to be construed in any limiting manner whatsoever. According to a further embodiment, the dimensions, quantities, of any and all embodiments provided herein are merely for purposes of illustration only, and can change as circumstances warrant, and the same shall be considered different and various aspects of the embodiments.

According to further embodiments, front end scented portion 24 of scented projectile 50 is about two-thirds the total length of scented projectile 50, and thus rear end unscented portion 22 is about one-third of the total length of scented projectile 50. According to a further embodiment, rear end unscented portion 22 needs to be just long enough so that an average sized hunter 6 can manipulate scented projectile 50 without getting any scent 14 from front end scented portion 24 on their fingers. According to a further embodiment, scented projectiles 50 can be packaged in a container such that individual scented projectiles 50 can be retrieved by hunter 6 without disturbing the remaining scented projectiles 50. This substantially prevents scent 14 from dissipating from the remaining scented projectiles 50 by inadvertent exposure to air.

Note that in FIG. 2A, scented projectile 50a is in the form of a cylinder: when expelled from airgun 100, scented projectile 50a will travel through the air, and begin to tumble relatively soon after firing. According to an embodiment, airgun 100 is in the general shape of a revolver or pistol, and includes barrel 180 with or without rifling In the former case, scented projectile 50 can spin in accordance with well-known rifling techniques that increase the aerodynamic stability of scented projectile 50, thus improving both range and accuracy of scented projectile 50. In the latter case, according to an embodiment, scented projectile 50 will simply travel down the barrel in a non-rotating manner, and will soon begin to tumble in the air after discharge from the barrel. Thus, in FIGS. 2F-J, the cross sectional shape of scented projectile 50 (as viewed from either end) can be square, rectangular, oval, triangular, octagonal, and so on. Thus, scented projectile 50 and hence its accompanying barrel interior design does not need to be cylindrical, as FIG. 2F illustrates (which corresponds to the embodiment of FIG. 2A). According to an embodiment, in a non-rifled, hence tumbling mode, the shape of scented projectile 50 can be practically any shape and those shown in FIGS. 2F-2J are merely for illustrative purposes only and are not to be construed in a limiting manner. Merely for purposes of illustration, FIGS. 2F-2J correspond to FIGS. 2A-2E (i.e., 2F to 2A, 2G t 2B, and so on).

FIG. 2B illustrates another embodiment of scented projectile 50, denoted as scented projectile 50b. In FIG. 2B it can be seen that scented projectile 50b now includes elliptical head 26a, that is formed at a foremost portion of front portion 24; in this embodiment, scented projectile 50b more closely resembles in shape a conventional bullet. Although not shown, reservoir 30 could be included in the embodiment shown in FIG. 2B. According to an embodiment, in the non-rifling mode, elliptically shaped head portion 26a can facilitate the travel of scented projectile 50b through the air towards its intended target, at least for a somewhat longer period of time than the embodiment of FIG. 2A, with the blunt end of front portion 24. According to an embodiment, as with scented projectile 50a, rear portion 22 of scented projectile 50b can be comprised of unscented processed projectile substance 34, while front portion 24 and elliptically shaped head 26a of scented projectile 50b can be comprised of scented processed projectile substance 34. According to a further embodiment, all of scented projectile 50b can be comprised of scented processed projectile substance 34. In the rifling mode, according to an embodiment, scented projectile 50b will act similarly to a conventional bullet. Corresponding non-cylindrical scented projectile 50g, shown in FIG. 2G, would not be fired in a rifled mode, and hence would tumble soon after be shot.

FIG. 2C illustrates another embodiment of scented projectile 50, denoted as scented projectile 50c. In FIG. 2C it can be seen that scented projectile 50c now includes cone shaped head 26b, that is formed at a foremost portion of front portion 24; in this embodiment, scented projectile 50c somewhat resembles in shape, a conventional bullet. Although not shown, reservoir 30 could be included in the embodiment shown in FIG. 2C. According to an embodiment, cone shaped head portion 26b can facilitate the travel of scented projectile 50c through the air towards its intended target, at least for a somewhat longer period of time than the embodiment of FIG. 2A, with the blunt end of front portion 24. According to an embodiment, as with scented projectile 50a, rear portion 22 of scented projectile 50c can be comprised of unscented processed projectile substance 34, while front portion 24 and cone shaped head 26b of scented projectile 50c can be comprised of scented processed projectile substance 34. According to a further embodiment, all of scented projectile 50c can be comprised of scented processed projectile substance 34. In the rifling mode, according to an embodiment, scented projectile 50c, shown in FIG. 2C, would act similar to a conventional bullet, and the corresponding non-cylindrical scented projectile 50h, shown in FIG. 2H, would not spiral due to lack of rifling.

FIG. 2D illustrates another embodiment of scented projectile 50, denoted as scented projectile 50d. In FIG. 2D it can be seen that scented projectile 50d now includes spherically shaped head 26c, that is formed at a foremost portion of front portion 24; in this embodiment, scented projectile 50d somewhat resembles in shape, a conventional bullet. Although not shown, reservoir 30 could be included in the embodiment shown in FIG. 2D. According to an embodiment, spherically shaped head 26c can facilitate the travel of scented projectile 50d through the air towards its intended target, at least for a somewhat longer period of time than the embodiment of FIG. 2A, with the blunt end of front portion 24. According to an embodiment, as with scented projectile 50a, rear portion 22 of scented projectile 50d can be comprised of unscented processed projectile substance 34, while front portion 24 and spherically shaped head 26c of scented projectile 50d can be comprised of scented processed projectile substance 34. According to a further embodiment, all of scented projectile 50d can be comprised of scented processed projectile substance 34. In the rifling mode, according to an embodiment, scented projectile 50d, shown in FIG. 2D, would act similar to a conventional bullet, and the corresponding non-cylindrical scented projectile 50i, shown in FIG. 2I, would not spiral due to lack of rifling.

FIG. 2E illustrates still a further embodiment of scented projectile 50, denoted as scented projectile 50e. In FIG. 2E it can be seen that scented projectile 50e now incorporates membrane 28 that covers all, or substantially all of scented projectile 50e. Shown also in FIG. 2E is reservoir 30 that can contain liquid/gelatinized scent 40. According to an embodiment, membrane 28 provides a means for preventing oils from scent 14, which is imbued in scented processed projectile substance 34, from getting on the fingers of hunter 6. In use, when hunter 6 places scented projectile 50e with membrane 28 covering it into projectile delivery device 100, membrane 28 can be peeled away prior to insertion, or the physical act of insertion itself and cause membrane 28 to peel away, upon which it can then be discarded. According to a further embodiment, membrane 28 can be made of any one of plastic, paper, foil, tissue, and like materials that are relatively very thin, easily torn, can be recycled and/or are made of materials that are biodegradable (even some plastics are fairly biodegradable).

According to a further embodiment, use of membrane 28 means that all of scented projectile 50e can be comprised of scented processed projectile substance 34, and hunter 6 will be substantially or completely prevented from accidental physical exposure to the oils from scent 14. Still further according to an embodiment, reservoir 30 with liquid/gelatinized scent 40 can be included in all of scented projectiles 50a-d, as can membrane 28, and still further according to an embodiment, the inclusion of membrane 28 does not necessarily mean that scented projectile 50 is comprised entirely of scented processed projectile substance, but that, as discussed above, only front portion 24 can be comprised of scented processed projectile substance 34 while rear portion 24 of scented projectile 50 can be comprised of unscented processed projectile substance 34. Scented projectile 50e, as shown in FIG. 2E, could be used in rifling mode, but scented projectile 50j, as shown in FIG. 2J, could not. As with scented projectile 50a-d, membrane 28 could be used in any of scented projectiles 50f-I, with or without reservoir 30 and liquid/gelatinized scent 40.

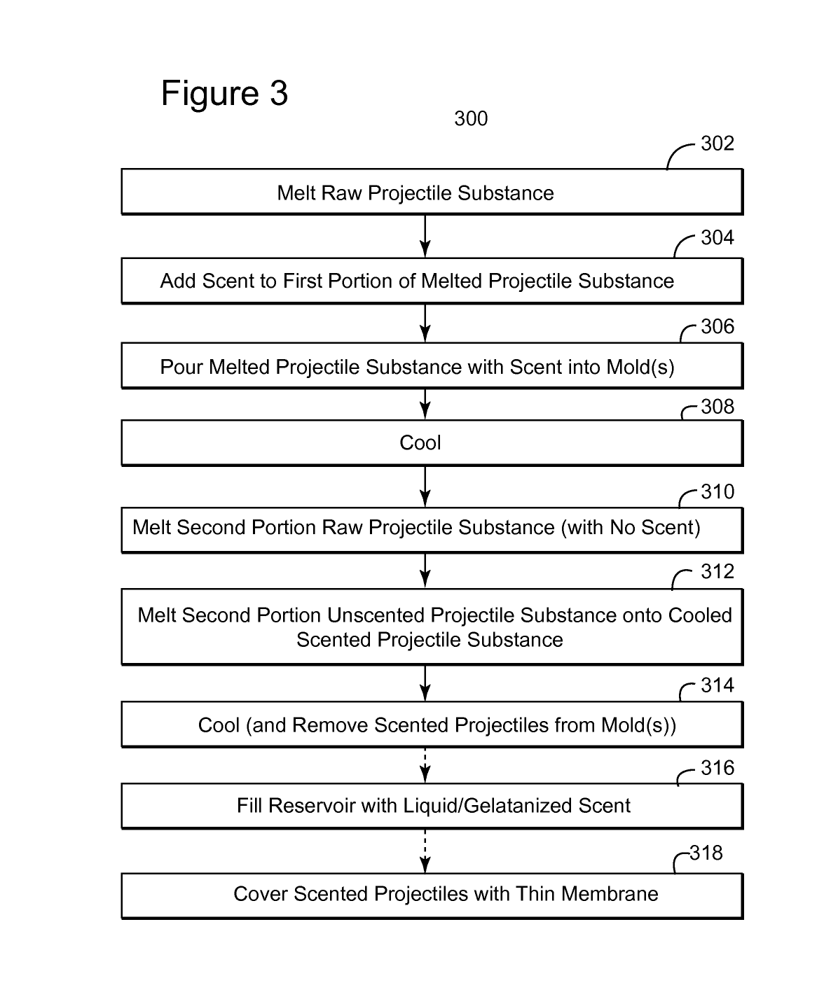

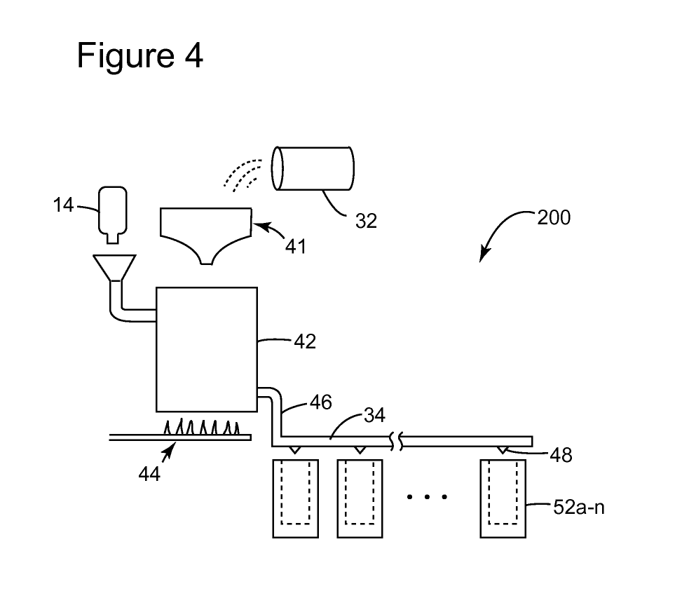

FIG. 3 illustrates method flowchart 300 for the manufacture of scented projectiles 50 according to an embodiment, and FIG. 4 illustrates an apparatus 200 that can be used to manufacture scented projectiles 50 according to an embodiment. Method 300 is a general embodiment, because, as described above, there are several different embodiments of scented projectile 50a-e that can be manufactured with essentially the same materials but with different molds, that can require slightly different process steps. Further, as those of skill in the art can appreciate, method 300 is greatly simplified as is the description thereof, for the dual purposes of clarity and brevity.

Method 300 begins with step 302, wherein raw projectile substance 32 is melted, after being pouring through funnel 41 into melting vat 42. Melting vat 42 has heat source 44 (shown in this case as gas burner, but could be, in further embodiments, an electrical heat source, among other types), for heating melting vat 42 to melt raw projectile substance 32. According to an embodiment, a first vat could hold a first portion of raw projectile substance 32 to which scent 14 is added, and a second vat could hold a second portion of raw projectile substance 32, to which scent 14 is not added. Or, a single vat could be used with appropriate cleaning as warranted between method steps. In step 304, melted raw projectile substance 32 has added to it scent 14, thereby creating scented processed projectile substance 34. In step 306, scented processed projectile substance 34 is poured into molds 52a-n via piping 46, and nozzles 48. In this particular embodiment, the molds 52 are designed to create the embodiment of scented projectile 50a of FIG. 2A. Thus, enough melted scented processed projectile substance 34 is poured into each of molds 52a-n to create front portion 24 of scented projectile 50. Then, in step 308, the hot melted scented projectile substance 34 is allowed to cool, so that then when unscented processed projectile substance 34 is next poured into molds 52a-n on top of the now hardened scented projectile substance 34 it will not mix with it, and instead will remain on top of the lower portion, forming rear-unscented-portion 22 of scented projectile 50a. In step 310 additional raw unprocessed projectile substance 32 is melted, in step 312 it is poured on top of the now hardened scented projectile substance 34, whereupon the unscented melted projectile substance 32 is allowed to cool (step 314), and taken out of molds 52a-n.

According to further embodiments, if it is desired to make the entire scented projectile 50 out of scented processed projectile substance 34, and to add membrane 28, then steps 308-312 are not required, and no additional raw projectile substance 32 is needed. Then, an optional processing step would be the addition of membrane 28 (optional method step 318), which could be done manually (all of steps of method 300 can be done manually, automatically, or via some combination thereof), or via some machine (not shown). Further, the embodiments of scented projectile 50 shown in FIGS. 2B-D only require different molds 52, and no different process steps than what was discussed above. According to further embodiments, if reservoir 30 was desired, then somewhat different, slightly more complicated processing steps could be required, wherein each mold is made of two halves, with reservoir 30 formed therein, and the two halves can be joined together with additional melted raw projectile substance 32. Other methods for forming reservoir 30 exist in the molding arts, as those of skill in the art can appreciate. Liquid/gelatinized scent 40 can then be inserted via a needle, or some other means, as those of skill in the art can surely appreciate (optional method step 316. According to a further embodiment, while some steps will occur prior to others (heating, for example, generally comes prior to cooling), several of the steps discussed above could be exchanged in order for others, as those of skill in the art can appreciate, without affecting any aspects of the embodiments. By way of a non-limiting example only, method steps 304 and 306 could come after method steps 310 and 312.

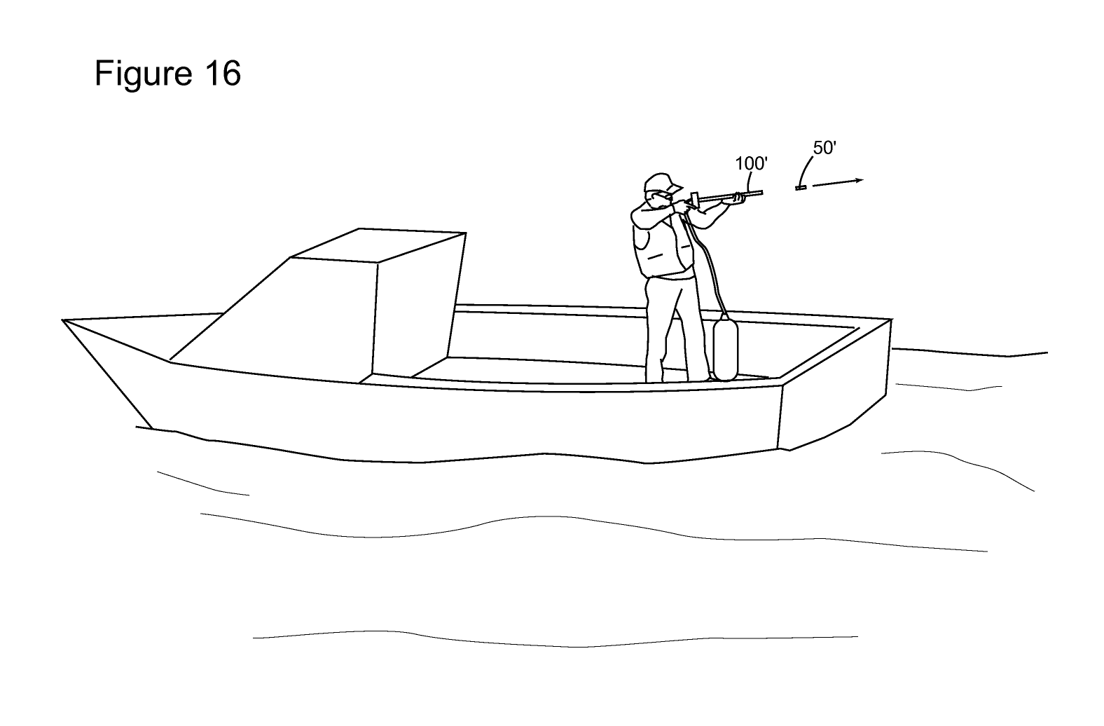

Raw projectile substance 32 is a mixture of several different compounds in varying amounts, including, but not limited to the following (on a per-scented projectile 50 basis, on average): water 70 ml; di-propylene glycol 30 ml; sodium stearate 15 ml; sorbitan stearate 5 ml; fumed silica 15 ml; and polysorbate 20 5 ml. According to a further embodiment, processed projectile substance 34 includes all of the compounds and materials of raw projectile substance 32, plus the addition of heat, till the mixture reaches between about 110° to about 120° Fahrenheit. and the addition of different scents 14, including, but not limited to deer, bear, fox, coyote, rabbit, beaver, groundhog, among others, both male and female, and female in estrous. According to a further embodiment, each of the different scents is generally a urine sample. As those of skill in the art can appreciate, female estrous urine is generally only effective as an attractant for about 2-3 weeks, and perhaps as many as 4 weeks in the year, while the “rut” or mating season is ongoing. According to a further embodiment, scent 14 can further be made to be or replicate “chum” or some other type of food source, and when projectile 50′ is so manufactured, it can be used as a lure while fishing for, by way of example, sharks. FIG. 16 illustrates a marine use of airgun 100′ which can be substantially larger than airgun 100 for use in terrestrial hunting. Airgun 100′ is connected to a SCUBA tank as a source for compressed gas to drive scented projectile 50′. According to a further embodiment, scented projectile 50′ could be covered in a water soluble membrane that dissolves very rapidly upon contact with water, for example salt water in the ocean. In other instances, projectile 50 with a “food” scent 14 can also be used for fishing in streams, lakes, ponds, and the like. According to a further embodiment, scented projectile 50 is water soluble. In either or both of these cases, scented projectile 50 could be manufactured in a substantially larger version (as much as 2-5 times as large) than in a typical game hunting scenario.

According to a further embodiment, raw projectile substance 32 is a mixture of several different compounds in varying amounts, for example, relative amounts of the following ingredients that include: 40 parts water; 30 parts propylene glycol; 30 parts animal urine; 10 to 15 parts sodium sterate; and 15 parts amorphous fumed silica. According to a further embodiment, processed projectile substance 34 includes all of the compounds and materials of raw projectile substance 32, plus the addition of heat, and the addition of different scents 14, including, but not limited to deer, bear, fox, coyote, rabbit, beaver, groundhog, among others, both male and female, and female in estrous.

According to an embodiment, the above ingredients are mixed together, heated to approximately 160° F., and then between about 10 to about 15 parts sodium sterate are added to the heated mixture, along with 15 parts of amorphous fumed silica. Once the ingredients have been thoroughly heated, and mixed in a heating state, the mixture is allowed to cool until the mixture reaches about 125° F. A further step in the process can be to reheat the mixture, with no lid, to allow water evaporation, which increases the relative concentration of the mixture

According to a further embodiment, as discussed above, the substance that makes up the scented and unscented portions of scented projectile 50 can be a wax material, though this is not necessarily always the case. In the process of making the scented projectile 50, raw projectile substance 32 is a wax, and according to a further embodiment, a combination or mixture of different materials that is heated and then allowed to cool, as described above, to form processed projectile substance 34. According to a further embodiment, the end portion of scented projectile 50 can be made of wax, even if the front portion is made of a different substance or mixture. Once the projectile substance 32 is melted and then cooled (with and without scent 14, among other ingredients), the hardness of processed projectile substance 34 increases, using an appropriate hardness scale.

There are many different indices of hardness that can be used to characterize just about any non-liquid, non-gaseous substance. As those of skill in the art can further appreciate, many of the hardness indices that exist can be correlated with each other, such that knowing a hardness index value in a first hardness index scale a second hardness index value in a second (or third, fourth, and so on) hardness index scale can be quickly ascertained. However, not all hardness indices are translatable, as some are useful for substantially harder materials (such as concrete, steel, and the like), while others apply only to substantially softer materials (such as wood, fibers, wax, and the like). Examples of hardness indices include Binnel, Rockwell, Knoop, Leeb, Vickers, among others.

Projectile Delivery Device (Airgun) 100

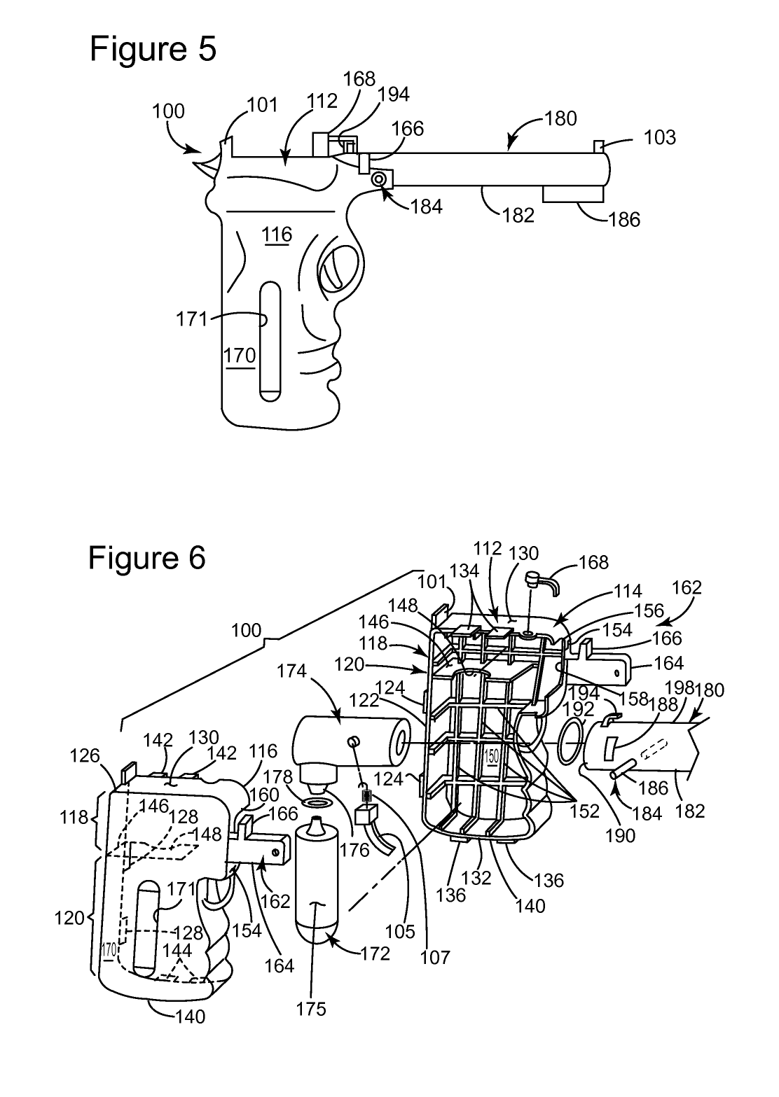

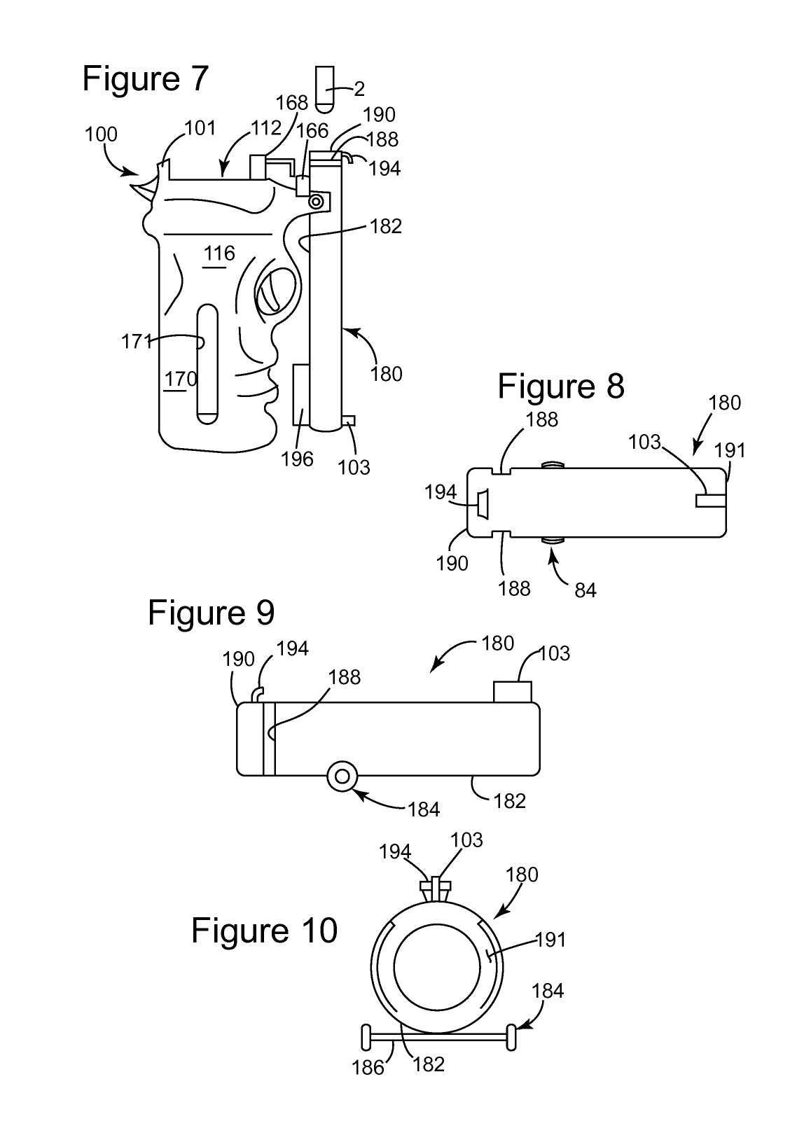

FIG. 5 is a perspective view of an embodiment of collapsible scent distributing airgun (airgun) 100, showing airgun 100 having barrel 80 moved to an extended position according to an embodiment, FIG. 6 is an exploded view of airgun 100 of FIG. 5, FIG. 7 is side view of airgun 100 of FIG. 5, showing barrel 80 moved to a collapsed position to permit scented projectile to be loaded into the barrel, FIG. 8 is a top view of barrel 80 of FIG. 5, FIG. 9 is a side view of barrel 80 of FIG. 5, and FIG. 10 is a front end view of barrel 80 of FIG. 5.

Airgun 100 can include a body 112 that in this form can be a pistol grip. As shown in FIG. 6, body 112 can have first and second clamshell portions 114, 116 that can be held together in a closed position to define upper and lower seats 118, 120. By way of example, first clamshell portion 114 can have a back surface 122 with a pair of hinge elements 124 and second clamshell portion 116 can have a back surface 126 with a pair of hinge elements 128 that can be pivotally attached to hinge elements 124 to permit body 112 to move between open and closed positions. Further, first clamshell portion 114 can have top and bottom surfaces 130, 132 that can include a respective pair of snap-fit fasteners 134, 136 and second clamshell portion 116 can further include top and bottom surfaces 138, 140 that can include a respective pair of snap-fit fasteners 142, 144, which can be attached to snap-fit fasteners 134, 136 to hold body 112 in the closed position. As those of skill in the art can appreciate, body 112 can instead have any number of portions that may be attached together by any suitable fasteners. In addition, airgun 100 can further include one or more partitions 146 that can be carried by first and/or second clamshell portions 114, 116. Partitions 146 can be disposed between upper and lower seats 118, 120 and can also have opening 148 through which upper and lower seats 118, 120 can mechanically communicate with each other during assembly. In addition, each of first and second clamshell portions 114, 116 can be made of plastic, other materials known to those of skill in the art including, for example, carbon fiber, fiberglass, among other materials, and can include inner surface 150 with a plurality of ribs 152 or webbing to reinforce a respective one of clamshell portions 114, 116. As those of skill in the art can further appreciate, body 112 can instead be made of metal or other non-plastic materials including, for example, wood. Body 112 can also include front surface 154 including orifice 156 that may be mechanically communicated with upper seat 118 during assembly. Orifice 156 in this form can be defined by a pair of notches 158, 160 formed in a respective one of first and second clamshell portions 114, 116 and aligned together when clamshell portions 114, 116 are moved to the closed position. Body 112 can also include pivotal coupling 162, which in this form can be a pair of cantilevered arms 164 extending from front surface 154 of body 112. Pivotal coupling 162 can further include one or more guide members 166, such as a pair of tongues that can extend from a respective one of the cantilevered arms 164. As those of skill in the art can appreciate, pivotal coupling 162 and guide members 166 can be any suitable pivoting fastener subassembly. Body 12 can further include cam lock 168 or other fastener pivotally carried by top surface 130 of first clamshell portion 114. Moreover, first and/or second clamshell portions 114, 116 can further include lateral surface 170 that can extend between front and back surfaces 154, 126. Each lateral surface 170 can have an opening 171 that can be communicated with lower seat 120.

Airgun 100 can also include gas cartridge 172 that can be carried by body 112. Gas cartridge 172 in this form can be received within lower seat 120 of body 112. However, gas cartridge 172 can be carried by any portion of body 112. Further, gas cartridge 172 can contain any amount of any suitable pressurized gas (gas) 175, such as 12 grams of carbon dioxide, among other types.

Airgun 100 can also further include pressure regulator valve (regulator) 174 that can be carried by body 112 and communicated with gas cartridge 172 to release gas 175 from the cartridge 72 at a constant rate, despite the pressure in gas cartridge 172 decreasing as airgun 100 is being used. Regulator 174 in this form can be received within upper seat 118 of body 112. As those of skill in the art can further appreciate, regulator 174, however, can be carried by any portion of body 112. Regulator 174 can be a conventional pressure regulator and can include piercing valve 176, which may extend through opening 148 in partition 146 and connect to gas cartridge 172. Further, regulator 174 can include O-ring 178 sandwiched between piercing valve 176 and gas cartridge 172. Airgun 100 can also be coupled to an external pressurized gas source, for example, a large pressurized carbon dioxide tank, or a pressurized air tank that is typically used for SCUBA operations.

Airgun 100 according to an embodiment, can also include barrel 180 pivotally carried by body 112 and movable by, for example, about 90 degrees between an extended position (as seen in FIG. 5) and a collapsed position (as seen in FIG. 8). Referring now to FIGS. 8-10, barrel 180 can include bottom side 182 including pivotal coupling 184 that can be fastened to reciprocal pivotal coupling 162 of body 112. As those of skill in the art can appreciate, pivotal coupling 184 can be carried by any portion of barrel 180. As best shown in FIG. 8, pivotal coupling 184 according to an embodiment can be cross bar 186 having a middle portion coupled to the bottom side of barrel 180 and extending transversely outward therefrom. Cross bar 186 can include a pair of opposing ends that can be pivotally carried by cantilevered arms 164 of body 112. Further, barrel 180 can also have one or more guide members 188 that can be coupled to guide members 166 of body 112 to position an end 190 of barrel 180 in the extended position so that O-ring 192 can be sandwiched between end 190 of barrel 180 and regulator 174 and further so that barrel 180 can be mechanically and in a gas-exchanging manner communicated with regulator 174 to receive pressurized gas 175 therefrom. Each guide member 188 in this form can be a groove configured to receive a respective one of tongues 166 on body 112. In addition, barrel 180 can also have top surface 130 including latch 194 or other fastener that can be coupled to cam lock 168 carried by body 112 to hold barrel 180 in the extended position and further decrease leakage of gas 175. Barrel 180 of airgun 100 further includes front end 191.

Referring again to FIG. 5, airgun 100 can also include laser sight 196 carried by bottom side 182 of barrel 180 or other suitable portion thereof. Laser sight 196 can be further adapted to facilitate aiming airgun 100 at a desired target. Barrel 180 can further include top side 198 with front sight 103 mounted thereon, and top surface 130 of body 112 can include rear sight 101 configured to align with front sight 103 for aiming airgun 100 at the desired target.

Referring to FIG. 6, airgun 100 can also include trigger 105 pivotally carried by body 112 and coupled to regulator 174 to selectively direct pressurized gas 175 into barrel 180 when trigger 105 is moved to a pressed position. Airgun 100 can also include biasing member 107, such as a torsional spring, that can be coupled to trigger 105 to move trigger 105 to an un-pressed position (i.e., to return to a ready position for the next firing).

In use, barrel 180 of airgun 100 can be pivoted, for example, by about 90 degrees from the extended position (shown in FIG. 5) to the collapsed position (shown in FIG. 7). Thereafter, scented projectile 50 can be inserted into the end of barrel 180. Barrel 180 can then be returned to its extended position so that guide members 166, 188 are engaged to each other to sandwich O-ring 192 between regulator 174 and end 190 of barrel 180 thereby mechanically and in a gas-exchanging manner communicating barrel 180 with regulator 174, which is in turn communicated in a gas-exchanging manner with gas cartridge 172. In addition, cam lock fastener 168 can be fastened to latch 194 in a locked position to hold barrel 180 in the extended position, facilitate compression of O-ring 178 and decrease leakage of pressurized gas (gas) 175 between regulator 174 and barrel 180. Trigger 105 can be pressed or pulled to direct a predetermined amount of pressurized gas 175 from gas cartridge 172 through regulator 174 and into barrel 180 to launch scented projectile 50 somewhat consistent distance, such as about 75 feet. In addition, ambient air can be drawn through opening 148 in lateral surface 170 of body 112 to transfer heat to cartridge 172 and regulator 174 and prevent airgun 100 from freezing. According to a further embodiment, all of the embodiments of scented projectile 50 discussed above, 50a-e, including modifications thereof consistent with this disclosure, can be shot from airgun 100. According to a further embodiment, a user could also slide scented projectile 50 down barrel 180 without rotating it as discussed above, and manually push scented projectile 50 into barrel 180 such that it is ready for use.

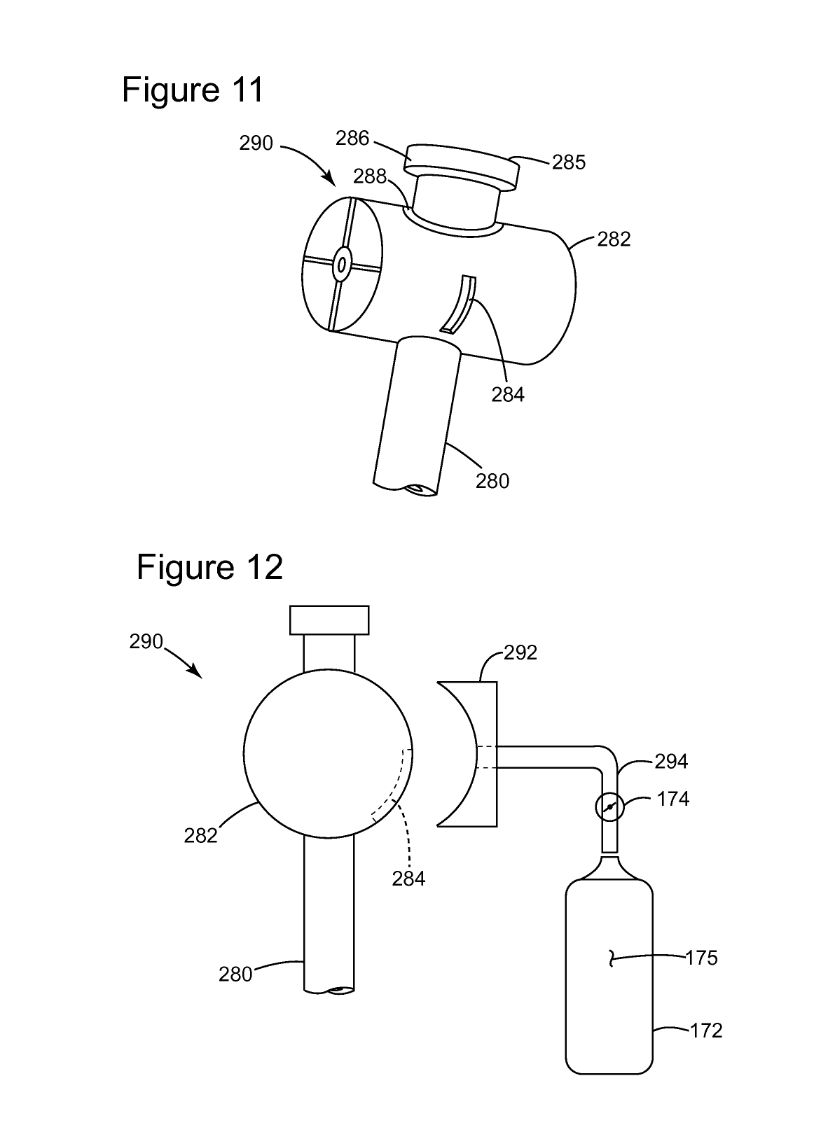

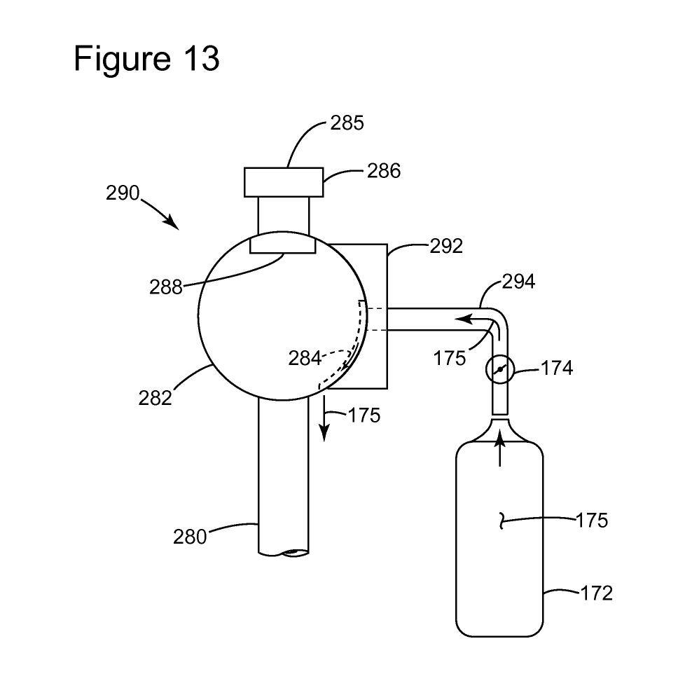

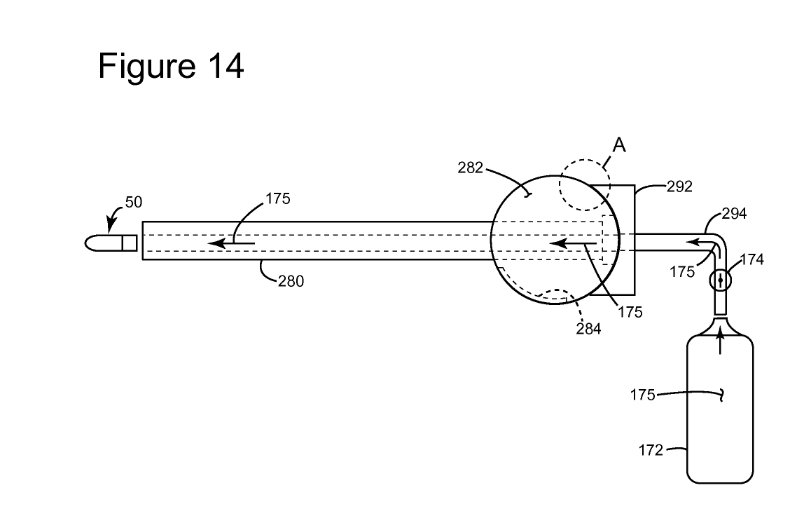

FIG. 11 is a perspective view of rotatable barrel assembly 290 for use with airgun 100 according to a further embodiment. FIG. 12 is a side view of rotatable barrel assembly 290 of FIG. 11, FIG. 13 is a side view of rotatable barrel assembly 290 of FIG. 11 in an accidental gas discharge mode according to an embodiment, and FIG. 14 is a side view of rotatable barrel assembly 290 of FIG. 11 in a normal gas and scented projectile discharge mode.

In order to fulfill the dual interests of clarity and brevity, a detailed description of the manner of mechanically interfacing rotatable barrel assembly 290 with airgun 100 will be omitted, as those of skill in the art can appreciate how trigger mechanisms work, as well as regulator mechanisms, and the like, all of which have been discussed in great detail above, and apply equally as well here. Instead, focus will be made on specific features of the embodiments shown in FIGS. 11-14 particular to a different operation as effected by rotatable barrel assembly 290 with airgun 100.

Rotatable barrel assembly 290 includes removable barrel 280 and rotatable barrel holder 282. Removable barrel 280 is configured to slidingly fit into rotatable barrel holder 282, which, in combination, is removably press or snap fitted into a reciprocal holding assembly, which is not shown in the Figures of airgun 100, but which those of skill in the art can appreciate operation thereof. Thus, rotatable barrel assembly 290 can be inserted and removed as a unit from airgun 100, and still mechanically and in a gas-exchanging manner communicate with the balance of the components of airgun 100, including, for example, regulator 174, trigger 105 and each of their corresponding and respective components such that when trigger 105 is pressed, a specific amount of gas 175 is discharged through removable barrel 280 (and which propels scented projectile 50, as discussed below).

Upon being inserted into airgun 100, rotatable barrel assembly 290 is generally not in the engaged condition, or shooting mode, though it might be. As previously, rotatable barrel assembly can rotate through about 90°, from a fully engaged position, reminiscent of the assembly shown in FIG. 5, to a fully dis-engaged condition, again as shown in FIG. 7. Removable barrel 280 can be retracted from rotatable barrel assembly 290 when in the dis-engaged condition, as shown in FIG. 7. Being able to remove removable barrel 280 provides the additional benefit of using different barrels for different scents, if desired, or to effectuate repairs of damaged/block barrels in the field, with very little difficulty.

In the disengaged condition, for example as seen in FIGS. 7, 12, and 13, hunter 6 can insert scented projectile 50 into removable barrel 280 at barrel upper end 285. FIG. 11 illustrates these components, as well as gas discharge channel 284. Removable barrel 280 slides into rotatable barrel holder 282, until barrel collar 286 fits slidingly into barrel collar receptacle 288, which is part of rotatable barrel holder 282. This can be seen, for example, in FIG. 14 (but in the fully engaged—gas 175 and scented projectile 50—discharge condition). When so configured, that is, when rotatable barrel assembly 290 is rotated to be engaged with gas delivery channel 294, removable barrel 280 is mechanically and in a gas-exchanging manner communicating with gas delivery channel 294 so that pressurized gas 175 can cause scented projectile 50 be discharged from airgun 100 according to an embodiment.

When rotatable barrel assembly 290 is in any position but the fully engaged gas-discharge condition (i.e., ready for firing), there is the possibility of pressurized gas 175 being accidently discharged from container 172, and causing a build-up of pressurized gas 175 at or near the exit portion of gas delivery channel 294. Since most often pressurized gas 175 is relatively benign and inert carbon dioxide, there is very little danger to anyone other than effect of components being subjected to large gas pressures that they otherwise might not normally encounter. Further, as those of skill in the art can appreciate, discharged pressurized gas, regardless of the type of gas, causes decreased temperatures in the vicinity of the discharged gas as well as the build-up of the gas in the immediate vicinity. Neither condition is welcome, especially the latter, though the former is to be expected. In order to alleviate such pressurized gas build-up conditions, gas discharge channel 284 has been incorporated into rotatable barrel holder 282 and which engages gas delivery channel 294 whenever rotatable barrel assembly rotates out of the fully engaged condition (FIG. 14). Pressurized gas 175 can then flow through gas discharge channel 284 whenever accidently discharge occurs and gas 175 can be released harmlessly into the atmosphere in a downward direction. Referring to FIG. 13, in the event pressurized gas 175 is inadvertently released from container 172, gas 175 travels through gas delivery channel 294 (which can include regulator 174, trigger 105, and associated components, as well as others discussed above), and into and out of gas discharge channel 284. Thus, pressure build up against removable barrel 280 is substantially or totally prevented.

FIG. 14 illustrates a side view of rotatable barrel assembly 290 of FIG. 11 in a normal gas and scented projectile discharge mode or condition. Presuming scented projectile 50 has been inserted into barrel upper end 285 of removable barrel 280, and then rotatable barrel assembly 290 is rotated into the fully engaged discharge condition, when hunter 6 presses trigger 105 (not shown in FIG. 14), pressurized gas 175 flows out of container 174 through gas delivery channel 294 and then against scented projectile 50. Released pressured gas 175 then pushed or forces scented projectile 50 out of removable barrel, and scented projectile 50 exits the other end of removable barrel 280 and flies towards its intended target. To fire another scented projectile 50, hunter 6 needs to rotate rotatable barrel 280 a certain number of degrees of rotation, and can then insert a new scented projectile 50 into rotatable barrel 280, and repeat as desired.

In both FIGS. 13 and 14, rotatable barrel assembly 290 can be seen to be rotationally engaged with holder mating fixture 292. Holder mating fixture 292 facilitates operation of airgun 100 in the following manner: when, as in FIG. 13, rotatable barrel assembly 290 is rotated into the disengaged condition or mode, rotatable barrel holder 282 fits and engages with holder mating fixture 292 such that there is a substantially seamless interface between gas delivery channel 294 and gas discharge channel 284. The substantially seamless interface results from the radius of curvature of rotatable barrel holder 282 and holder mating fixture 292 being substantially equivalent, such that when the press-fit/snap-fit mechanism (not shown) locks rotatable barrel assembly 290 into position with other components of airgun 100, rotatable barrel holder 282 and holder mating fixture 292 are mated with each other, in a male-female component fashion. Since barrel upper end 285 recesses substantially if not totally completely within barrel collar receptacle 288, barrel collar 286 does not interfere with holder mating fixture 292 when rotated into the discharge condition/mode, as shown in FIG. 14.

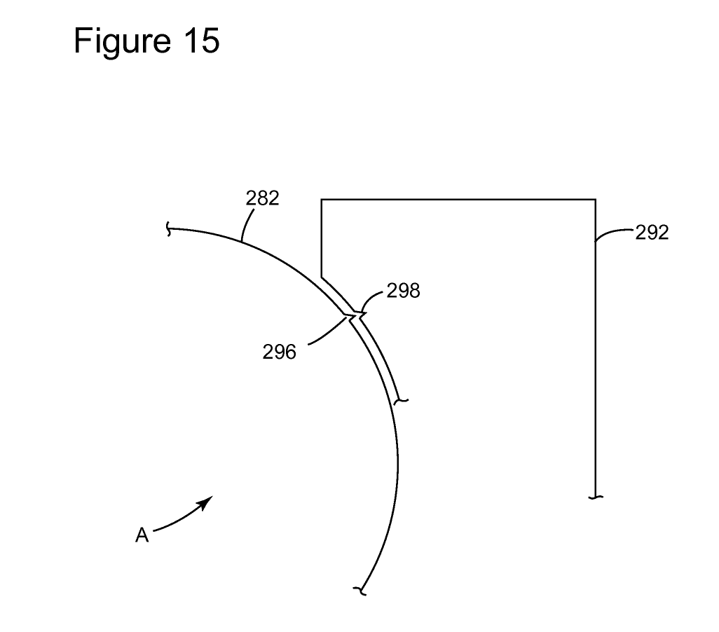

Also shown in FIG. 14 is circled area A, which is shown in greater detail in FIG. 15, which illustrates detent protrusion 296 that is part of rotatable barrel holder 282 and detent receptacle 298 that is part of holder mating fixture 292. When rotated into the discharge condition/mode, rotatable barrel assembly is semi-fixedly locked into such condition/mode by virtue of the interlocking mechanism of detent protrusion 296 and detent receptacle 298. No more than slight pressure or force is needed to engage the semi-locking function of detent protrusion 296 and detent receptacle 298, and no more than slight pressure or force is needed to dis-engage the semi-locking function of detent protrusion 296 and detent receptacle 298. However such slight the force may be, it is still slightly more than that which may be casually encountered during the process of loading and then firing airgun 100. The semi-locking function of detent protrusion 296 and detent receptacle 298 substantially prevents accidental discharge in directions not intended, which improves safety and efficacy of airgun 100.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

1. A scent carrying projectile, comprising:
a scented portion made of a scent-carrying substance; and
a unscented portion, adjacent to said scented portion, said unscented portion made of an unscented substance.

2. The projectile according to claim 1, wherein
said scent-carrying substance and said unscented substance are made of said same substance, and wherein
said scent-carrying substance includes a scent and said unscented substance does not include said scent.

3. The projectile according to claim 2, wherein said substance comprises:
a substance that is melted and then cooled and solidified, such that a first hardness in a pre-melted state is less than a second hardness in a post-melted state.

4. The projectile according to claim 1, wherein said scented portion and said un-scented portion are covered with a thin, unscented membrane.

5. The projectile according to claim 4, wherein
said membrane is made of at least one of paper, tissue, foil, and plastic.

6. The projectile according to claim 1, wherein said projectile is substantially cylindrically shaped.

7. The projectile according to claim 1, wherein said scented portion comprises:
a conically shaped scented front portion; and
a cylindrically shaped scented rear portion.

8. The projectile according to claim 7, wherein said unscented portion comprises:
a cylindrically shaped unscented front portion adjacent said cylindrically shaped scented rear portion of said cylindrically shaped scented portion; and
a cylindrically shaped unscented rear portion.

9. The projectile according to claim 1, wherein said scent includes urine selected from the group of male deer, female deer, female deer in estrous, male bear, female bear, female bear in estrous, male fox, female fox, female fox in estrous, male coyote, female coyote, and female coyote in estrous.

10. A scent carrying projectile, comprising:
a front conically shaped portion;
a middle cylindrically shaped portion, adjacent to the front conically shaped portion; and
an end cylindrical portion, adjacent to the middle cylindrical portion, wherein
said front and middle portions are made of a scent-carrying substance, and further wherein
said end cylindrical portion is made of an unscented substance.

11. The projectile according to claim 10, wherein
said scent-carrying substance and said unscented substance are made of said same substance, and wherein
said scent-carrying substance includes a scent and said unscented substance does not include said scent.

12. The projectile according to claim 11, wherein said same substance comprises:
a substance that is melted and then cooled and solidified, such that a first hardness in a pre-melted state is less than a second hardness in a post-melted state.

13. The projectile according to claim 10, wherein said projectile is covered with a thin, unscented membrane.

14. The projectile according to claim 10, wherein said middle cylindrically shaped portion includes a cavity filled with scent-carrying gel.

15. The projectile according to claim 10, wherein said middle cylindrically shaped portion includes a cavity filled with scent-carrying liquid.

16. The projectile according to claim 10, wherein said projectile is covered with a thin, unscented membrane.

17. The projectile according to claim 16, wherein
said membrane is made of at least one of paper, tissue, foil, and plastic.

18. The projectile according to claim 10, wherein said scent includes urine selected from the group of male deer, female deer, female deer in estrous, male bear, female bear, female bear in estrous, male fox, female fox, female fox in estrous, male coyote, female coyote, and female coyote in estrous.

19. A scent carrying projectile, comprising:
a cylindrically shaped scented portion made of a scent-carrying substance; and
a thin unscented membrane covering substantially all of said cylindrically shaped scented portion.

20. The projectile according to claim 19, further comprising:
a cavity in said projectile filled with scent-carrying gel.

21-41. (canceled)
